(19) United States
(12) Patent Application Publication
(10) Pub. No.: US 2015/0127719 A1
(43) Pub. Date: May 7, 2015

(54) INFORMATION PROCESSING SYSTEM, PROXY APPARATUS, INFORMATION PROCESSING METHOD, AND COMPUTER PROGRAM PRODUCT

(71) Applicant: Kabushiki Kaisha Toshiba, Minato-ku (JP)

(72) Inventors: Narumichi SAKAI, Kawasaki (JP); Hiroyuki Aizu, Yokohama (JP)

(73) Assignee: Kabushiki Kaisha Toshiba, Minato-ku (JP)

(21) Appl. No.: 14/446,532

(22) Filed: Jul. 30, 2014

(30) Foreign Application Priority Data
Nov. 5, 2013 (JP) 2013-229692

(51) Int. Cl. H04L 29/06

(52) U.S. Cl. CPC H04L 67/42
USPC 709/203

(57) ABSTRACT

According to an embodiment, an information processing system includes a unique information collector, a response changer, and a response transmitter. The unique information collector is configured to transmit a unique information request to a client apparatus, and receive unique information from the client apparatus. The unique information request is for requesting the unique information of the client apparatus. The response changer is configured to change, based on the unique information, a page included in a page response received from a server apparatus, and output the changed page, the page response responding to a page request transmitted from the client apparatus. The response transmitter is configured to transmit the changed page to the client apparatus.

### CROSS-REFERENCE TO RELATED APPLICATION

This application is based upon and claims the benefit of priority from Japanese Patent Application No. 2013-229692, filed on Nov. 5, 2013; the entire contents of which are incorporated herein by reference.

### FIELD

Embodiments described herein relate generally to an information processing system, a proxy apparatus, an information processing method, and a computer program product.

### BACKGROUND

In order to correctly display a web page (hereinafter, simply referred to as a page) provided by a web server apparatus (hereinafter, simply referred to as a server apparatus) on a display device of a client apparatus, the page needs to be changed according to, for example, the size of a browser or a display screen or the specifications of the display device.

For such an information processing system that changes a page, there is proposed a system in which, when a page request from a client apparatus is transmitted, information (hereinafter, referred to as unique information) for being correctly displayed on a display device of the client apparatus is added. In the information processing system, a proxy apparatus receives a page response from a server apparatus, changes a page according to unique information, and transmits the page to a client apparatus.

However, in a method in which, as described above, the proxy apparatus obtains unique information by the client apparatus transmitting a page request added with the unique information, due to the restrictions on the specification of the data configuration of the page request, the types of unique information to be obtained are limited.

In addition, there is another problem that, since unique information is transmitted from the client apparatus to the proxy apparatus, the client apparatus needs to know in advance of unique information requested by the proxy apparatus.

### BRIEF DESCRIPTION OF THE DRAWINGS

FIG. 1 is a diagram illustrating an exemplary configuration of an information processing system according to a first embodiment;

FIG. 2 is a diagram illustrating an example of a block configuration of the information processing system according to the first embodiment;

FIG. 3 is a sequence diagram illustrating an example of conventional page change operation;

FIG. 4 is a sequence diagram illustrating a summary of the operation of the information processing system according to the first embodiment;

FIG. 5 is a sequence diagram illustrating details of the operation of the information processing system according to the first embodiment;

FIG. 6 is a diagram illustrating an example of a data configuration of a unique information request;

FIG. 7 is a diagram illustrating an example of a configuration of a page change table;

FIG. 8 is a flowchart illustrating an example of the page change operation of a proxy apparatus;

FIG. 9 illustrates examples of a page to which a page change is made;

FIG. 10 is a diagram illustrating an example of a block configuration of an information processing system according to a variant of the first embodiment;

FIG. 11 is a diagram illustrating an example of a block configuration of an information processing system according to a second embodiment; and

FIG. 12 is a diagram illustrating an example of a block configuration of an information processing system according to a variant of the second embodiment.

### DETAILED DESCRIPTION

According to an embodiment, an information processing system includes a unique information collector, a response changer, and a response transmitter. The unique information collector is configured to transmit a unique information request to a client apparatus, and receive unique information from the client apparatus. The unique information request is for requesting the unique information of the client apparatus. The response changer is configured to change, based on the unique information, a page included in a page response received from a server apparatus, and output the changed page, the page response responding to a page request transmitted from the client apparatus. The response transmitter is configured to transmit the changed page to the client apparatus.

With reference to the drawings, information processing systems, proxy apparatuses, information processing methods, and programs according to embodiments of the present invention will be described in detail below. In the following drawings, the same parts are denoted by the same reference signs. Note, however, that the drawings are schematic and thus the relationship between thickness and planar dimensions, the ratio between the thicknesses of layers, etc., may differ from the real ones. Therefore, specific thicknesses and dimensions are to be determined taking into consideration the following description.

### First Embodiment

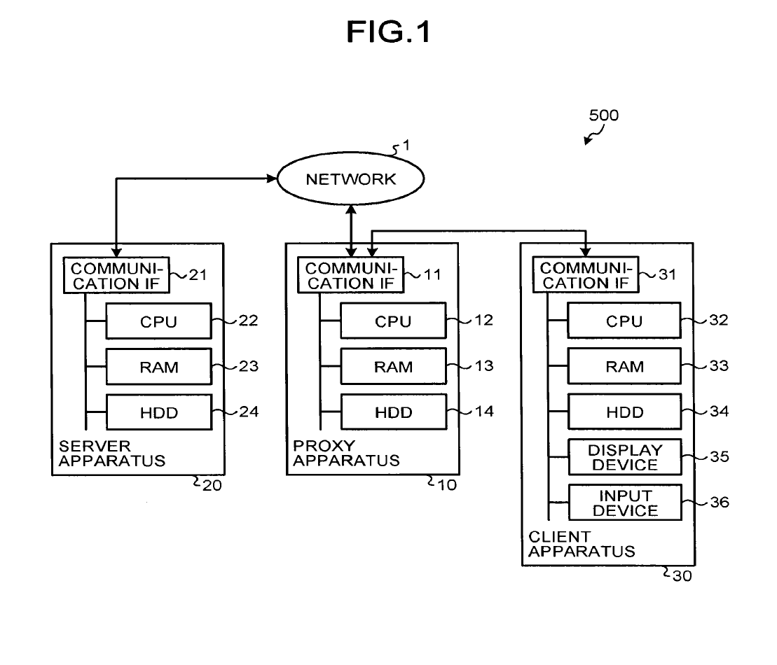

FIG. 1 is a diagram illustrating an exemplary configuration of an information processing system according to a first embodiment. With reference to FIG. 1, the overall configuration of an information processing system 500 and the hardware configurations of various types of apparatuses will be described.

As illustrated in FIG. 1, the information processing system 500 includes a proxy apparatus 10, a server apparatus 20, and a client apparatus 30. The proxy apparatus 10 and the server apparatus 20 are connected to each other through an external network 1. The client apparatus 30 is connected to the proxy apparatus 10 and is connected to the network 1 through the proxy apparatus 10. The network 1 is a network compliant with a wired communication protocol defined by IEEE (Institute of Electrical and Electronics Engineers) 802.3, etc., a wireless communication protocol defined by IEEE 802.11, or other protocols, and is implemented by a communication line such as a LAN (Local Area Network), the Internet, or a dedicated line.

Note that although in FIG. 1 only one client apparatus 30 connected to the proxy apparatus 10 is described, the configuration is not limited thereto, and a plurality of client apparatuses 30 may be connected.

Note also that although, as illustrated in FIG. 1, the client apparatus 30 is directly connected to the proxy apparatus 10, the configuration is not limited thereto, and for example, the client apparatus 30 may be connected to the proxy apparatus 10 through a LAN such as an intra-company network.

Note also that the “information processing system” is not limited to one configured by a plurality of information processing apparatuses, and has a concept also including a single information processing apparatus.

The proxy apparatus 10 is an apparatus functioning as a proxy server that relays a page request from the client apparatus 30 to the server apparatus 20, and relays a page response responding to the page request from the server apparatus 20 to the client apparatus 30. The page response is response information including a page requested by the client apparatus 30 and includes, for example, an HTML (HyperText Markup Language) file, a media file, a script, or the like, which is a resource composing a web page. The proxy apparatus 10 includes a communication interface 11, a CPU (Central Processing Unit) 12, a RAM (Random Access Memory) 13, and an HDD (Hard Disk Drive) 14. The above-described apparatuses are communicably connected to each other through a bus.

The communication interface 11 is an interface compliant with a protocol, e.g., TCP (Transmission Control Protocol)/IP (Internet Protocol), for communicating data with the client apparatus 30 through a network such as a LAN or directly, and communicating with the server apparatus 20 through the network 1. For example, when the communication interface 11 is compliant with TCP/IP, the communication interface 11 removes TCP and IP headers from data received from the server apparatus 20 and the client apparatus 30. In addition, when the communication interface 11 transmits data to the server apparatus 20 and the client apparatus 30, the communication interface 11 adds TCP and IP headers to the data. The communication interface 11 is implemented by a communication apparatus, e.g., a NIC (Network Interface Card).

The CPU 12 controls the overall operation of the proxy apparatus 10.

The RAM 13 is an apparatus that stores various types of programs including a proxy application which is executed by the proxy apparatus 10, data used in various types of processes performed by the proxy apparatus 10, and the like. The proxy application is executed by the CPU 12 on an OS (Operating System) loaded in the RAM 13.

The HDD 14 is a storage apparatus that accumulates and stores an OS, programs, data, or the like. Note that the HDD 14 is not limited to being implemented by an HDD and may be implemented by a storage apparatus, e.g., an SSD (Solid State Drive), an optical disk, or a Magneto-Optical Disk (MO).

The server apparatus 20 is an apparatus functioning as a web server that transmits a page response including a web page to the client apparatus 30 in response to a page request from the client apparatus 30. The server apparatus 20 includes a communication interface 21, a CPU 22, a RAM 23, and an HDD 24.

The communication interface 21 is an interface compliant with a protocol, e.g., TCP/IP, for communicating data with the proxy apparatus 10 through the network 1, and communicating data with the client apparatus 30 through the network 1 and the proxy apparatus 10. For example, when the communication interface 21 is compliant with TCP/IP, the communication interface 21 removes TCP and IP headers from data received from the proxy apparatus 10 and the client apparatus 30. In addition, when the communication interface 21 transmits data to the proxy apparatus 10 and the client apparatus 30, the communication interface 21 adds TCP and IP headers to the data. The communication interface 21 is implemented by a communication apparatus, e.g., a NIC (Network Interface Card).

The CPU 22 controls the overall operation of the server apparatus 20.

The RAM 23 is an apparatus that stores various types of programs including a server application which is executed by the server apparatus 20, data used in various types of processes performed by the server apparatus 20, and the like. The server application is executed by the CPU 22 on an OS deployed in the RAM 23.

The HDD 24 is a storage apparatus that accumulates and stores an OS, programs, various types of data, web pages responding to page requests from the client apparatus 30, and the like. Note that the HDD 24 is not limited to being implemented by an HDD and may be implemented by a storage apparatus, e.g., an SSD (Solid State Drive), an optical disk, or a Magneto-Optical Disk (MO).

The client apparatus 30 is an apparatus that transmits a page request for requesting a web page that a user desires to browse, to the server apparatus 20 and receives a page response including a requested page from the server apparatus 20 and then displays the page on a browser, etc. The client apparatus 30 includes a communication interface 31, a CPU 32, a RAM 33, an HDD 34, a display device 35, and an input device 36.

The communication interface 31 is an interface compliant with a protocol, e.g., TCP/IP, for communicating data with the proxy apparatus 10 through a network such as a LAN or directly, and communicating data with the server apparatus 20 through the network 1. For example, when the communication interface 31 is compliant with TCP/IP, the communication interface 31 removes TCP and IP headers from data received from the proxy apparatus 10 and the server apparatus 20. In addition, when the communication interface 31 transmits data to the proxy apparatus 10 and the server apparatus 20, the communication interface 31 adds TCP and IP headers to the data. The communication interface 31 is implemented by a communication apparatus, e.g., a NIC (Network Interface Card).

The CPU 32 controls the overall operation of the client apparatus 30.

The RAM 33 is an apparatus that stores various types of programs including a browser which is executed by the client apparatus 30, data used in various types of processes performed by the client apparatus 30, and the like. The browser, etc., are executed by the CPU 32 on an OS deployed in the RAM 33.

The HDD 34 is a storage apparatus that accumulates and stores an OS, programs such as a browser, various types of data, and the like. Note that the HDD 34 is not limited to being implemented by an HDD and may be implemented by a storage apparatus, e.g., an SSD (Solid State Drive), an optical disk, or a Magneto-Optical Disk (MO).

The display device 35 is an apparatus that displays, by a browser, various types of images such as pages received from the server apparatus 20. The display device 35 is implemented by, for example, a CRT (Cathode Ray Tube) display, a liquid crystal display, a plasma display, or an organic EL (Electroluminescence) display.

The input device 36 is an apparatus used by the user to perform operation inputs to allow the CPU 32 to perform predetermined processes. The input device 36 is implemented by an operation input function, e.g., a mouse, a keyboard, a numeric keypad, a touchpad, or a touch panel.

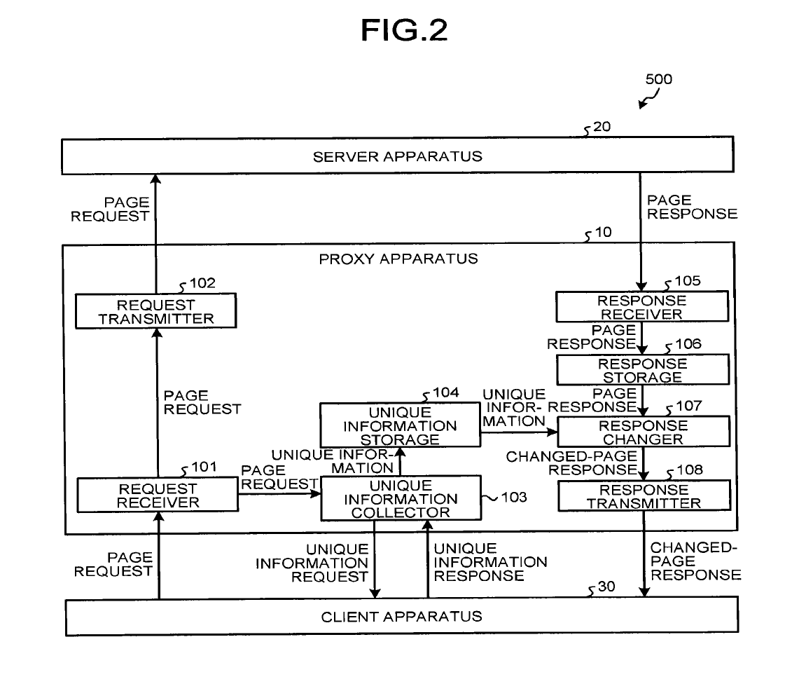

FIG. 2 is a diagram illustrating an example of a block configuration of the information processing system according to the first embodiment. With reference to FIG. 2, a block configuration of the information processing system 500, particularly, a block configuration of the proxy apparatus 10, will be described.

As illustrated in FIG. 2, the proxy apparatus 10 includes a request receiver 101, a request transmitter 102, a unique information collector 103, a unique information storage 104, a response receiver 105, a response storage 106, a response changer 107, and a response transmitter 108.

The request receiver 101 is a processor that receives a page request from the client apparatus 30 and passes the page request to the request transmitter 102 and the unique information collector 103. The request receiver 101, and the request transmitter 102, the response receiver 105, and the response transmitter 108 which will be described later are implemented by the communication interface 11.

The request transmitter 102 is a processor that receives the page request from the request receiver 101 and transmits the page request to the server apparatus 20 through the network 1.

The unique information collector 103 is a processor that receives the page request from the request receiver 101 and transmits a unique information request instructing about the type, obtaining method, etc., of unique information required for page change operation, to the client apparatus 30 identified by the page request. Here, the unique information collector 103 can identify the client apparatus 30 having transmitted the page request, by information identifying the client apparatus 30 which is included in the page request. The method of identifying a client apparatus 30 by a page request is the same in the following. In addition, the unique information collector 103 receives a unique information response from the client apparatus 30 and passes unique information included in the unique information response, to the unique information storage 104 of the proxy apparatus 10. The unique information is information about the client apparatus 30, such as information on a client application such as a browser which operates on the client apparatus 30. The unique information is information, e.g., the screen size and resolution of the display device 35, the type of the input device 36, the type of an application, benchmark results, and sensor information (illuminance, acceleration, camera video, temperature, or the like). The function of transmitting, by the unique information collector 103, a unique information request to the client apparatus 30 and the function of receiving, by the unique information collector 103, a unique information response from the client apparatus 30 are implemented by, for example, the communication interface 11. The function of generating, by the unique information collector 103, a unique information request to be transmitted to the client apparatus 30 and the function of extracting, by the unique information collector 103, unique information from a unique information response received from the client apparatus 30 and passing the unique information to the unique information storage 104 are implemented by a predetermined program which is deployed in the RAM 13 and executed by the CPU 12. Note that the function of generating, by the unique information collector 103, a unique information request to be transmitted to the client apparatus 30 and the function of extracting, by the unique information collector 103, unique information from a unique information response received from the client apparatus 30 and passing the unique information to the unique information storage 104 may be implemented by hardware.

The unique information storage 104 stores the unique information received from the unique information collector 103, in association with identification information of the client apparatus 30 associated with the unique information. Therefore, the unique information storage 104 may store the unique information and the identification information of the client apparatus 30, as a relational database. The unique information storage 104 is implemented by at least one of the RAM 13 and the HDD 14.

The response receiver 105 is a processor that receives a page response from the server apparatus 20 through the network 1 and passes the page response to the response storage 106.

The response storage 106 stores the page response received from the response receiver 105. The response storage 106 is implemented by at least one of the RAM 13 and the HDD 14.

The response changer 107 is a processor that receives unique information associated with the client apparatus 30 that is identified by the page response received from the response storage 106, from the unique information storage 104. Based on the unique information, the response changer 107 page-changes a page included in the page response, according to the display specifications of a browser, etc., of the client apparatus 30. The response changer 107 passes a changed-page response including the page-changed page (changed page) to the response transmitter 108. The response changer 107 is implemented by a predetermined program which is deployed in the RAM 13 and executed by the CPU 12. Note that the response changer 107 may be implemented by hardware.

The response transmitter 108 is a processor that transmits the changed-page response received from the response changer 107, to the client apparatus 30.

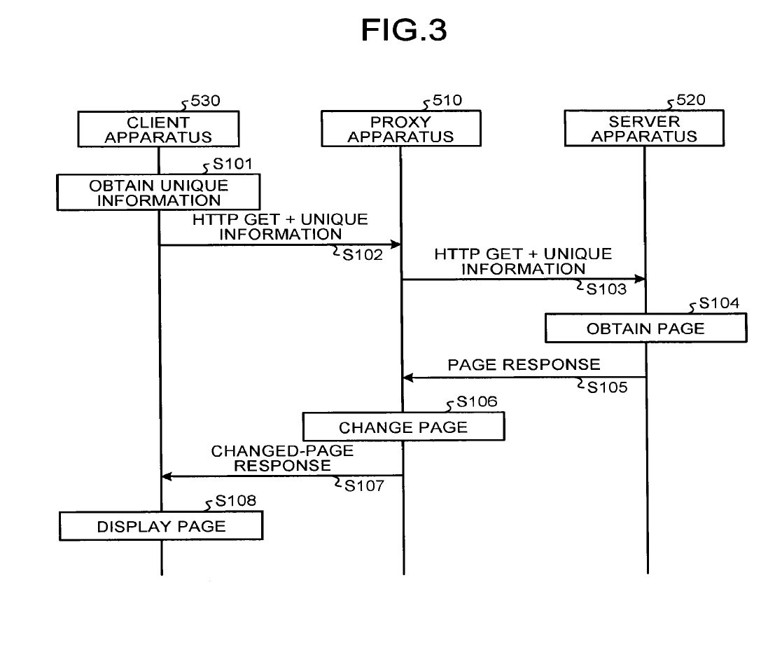

FIG. 3 is a sequence diagram illustrating an example of conventional page change operation. With reference to FIG. 3, operation, mainly, page change operation of a conventional information processing system, will be described.

As illustrated in FIG. 3, the information processing system includes a proxy apparatus 510, a server apparatus 520, and a client apparatus 530. A connection configuration between the apparatuses is the same as that illustrated in FIG. 1.

Step S101

The client apparatus 530 obtains unique information about the client apparatus 530 that is required by the proxy apparatus 510 for page change operation which will be described later.

Step S102

The client apparatus 530 transmits a page request (HTTP (Hypertext Transfer Protocol) GET, etc.) for requesting a web page that a user desires to browse, added with the obtained unique information, to the proxy apparatus 510. Here, the client apparatus 530 needs to grasp in advance unique information required by the proxy apparatus 510. Furthermore, the client apparatus 530 can only add unique information based on the specification of “HTTP GET” or the like which is a page request, to the page request.

Step S103

The proxy apparatus 510 stores the unique information added to the received page request, and transmits the page request (HTTP GET, etc.) added with the unique information received from the client apparatus 530, to the server apparatus 520 through an external network. Namely, the proxy apparatus 510 has the function of relaying the page request from the client apparatus 530, to the server apparatus 520.

Step S104

Based on the page request received from the proxy apparatus 510, the server apparatus 520 obtains a page requested by the client apparatus 530, from a storage apparatus of the server apparatus 520 such as an HDD.

Step S105

The server apparatus 520 transmits a page response including the obtained page requested by the client apparatus 530, to the proxy apparatus 510 through the external network.

Step S106

Based on the unique information received at step S102, the proxy apparatus 510 page-changes the page included in the page response received from the server apparatus 520, according to the display specifications of the client apparatus 530.

Step S107

The proxy apparatus 510 transmits a changed-page response including the page-changed page (changed page) to the client apparatus 530 through an external network.

Step S108

The client apparatus 530 displays the changed page added to the received changed-page response, on a display device (not illustrated).

By the above-described operation, in the conventional information processing system, the proxy apparatus 510 page-changes a page received from the server apparatus 520, based on unique information received from the client apparatus 530, and transmits the page to the client apparatus 530, as a changed page. However, as described above, the client apparatus 530 needs to grasp in advance unique information required by the proxy apparatus 510. Furthermore, the client apparatus 530 can only add unique information based on the specification of “HTTP GET” or the like which is a page request, to the page request.

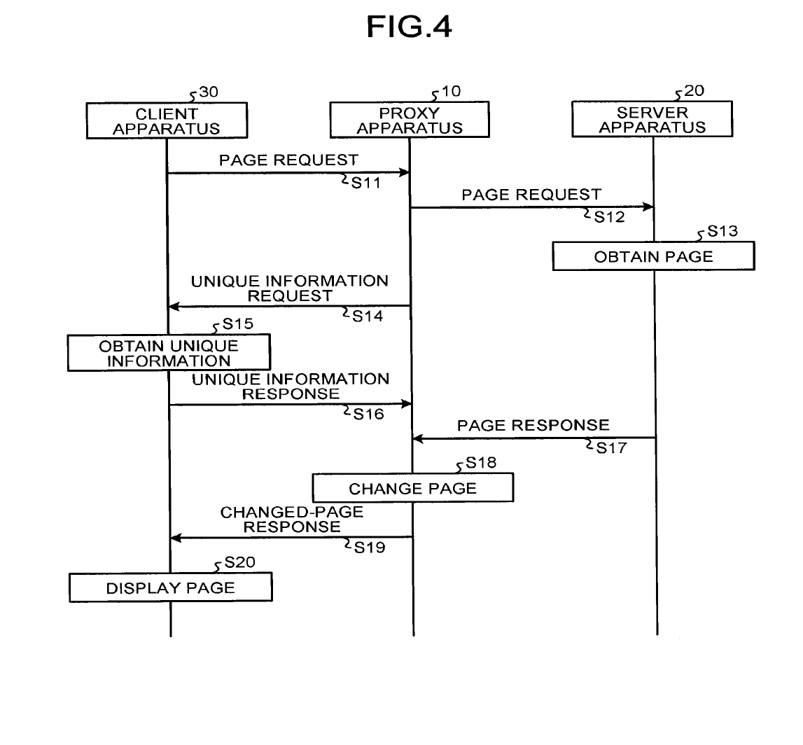

FIG. 4 is a sequence diagram illustrating a summary of the operation of the information processing system according to the first embodiment. With reference to FIG. 4, a summary of the operation of the information processing system 500 according to the present embodiment will be described.

Step S11

The client apparatus 30 transmits a page request for requesting a web page that a user desires to browse, to the proxy apparatus 10.

Step S12

The proxy apparatus 10 transmits the received page request to the server apparatus 20 through the network 1. Namely, the proxy apparatus 10 has the function of relaying the page request from the client apparatus 30, to the server apparatus 20.

Step S13

Based on the page request received from the proxy apparatus 10, the server apparatus 20 obtains a page requested by the client apparatus 30, from a storage apparatus of the server apparatus 20 such as the HDD 24.

Step S14

When the proxy apparatus 10 receives the page request from the client apparatus 30, the proxy apparatus 10 transmits a unique information request instructing about the type, obtaining method, etc., of unique information required for page change operation which will be described later, to the client apparatus 30 identified by the page request.

Step S15

The client apparatus 30 obtains unique information requested by the proxy apparatus 10, in response to the received unique information request.

Step S16

The client apparatus 30 transmits a unique information response including the obtained unique information, to the proxy apparatus 10.

Step S17

The server apparatus 20 transmits a page response including the page obtained at step S13, to the proxy apparatus 10 through the network 1.

Step S18

Based on the unique information included in the unique information response received at step S16, the proxy apparatus 10 page-changes the page included in the page response received at step S17, according to the display specifications of a browser, etc., of the client apparatus 30. Specific details of the page change operation will be described later.

Step S19

The proxy apparatus 10 transmits a changed-page response including the page-changed page (changed page) to the client apparatus 30.

Step S20

The client apparatus 30 displays the changed page added to the received changed-page response, on the display device 35.

As in the above-described operation, when the proxy apparatus 10 receives a page request from the client apparatus 30, the proxy apparatus 10 transmits a unique information request instructing about the type, obtaining method, etc., of unique information required for page change operation, to the client apparatus 30. Then, the proxy apparatus 10 obtains unique information from the client apparatus 30 and page-changes a page received from the server apparatus 20, based on the unique information. Therefore, the proxy apparatus 10 can specify to the client apparatus 30 required for page change operation, unique information related to display specifications, etc. In addition, since the client apparatus 30 does not need to know in advance of unique information requested by the proxy apparatus 10, flexibility in the type of unique information which is obtained from the client apparatus 30 can be improved.

Note that although, as illustrated in FIG. 4, it is described that the operation of transmitting a unique information request by the proxy apparatus 10 at step S14 is performed after the operation of obtaining a page by the server apparatus 20 at step S13, the configuration is not limited thereto. Specifically, as described above, the operation of transmitting a unique information request by the proxy apparatus 10 at step S14 may be performed any time after the proxy apparatus 10 receives a page request from the client apparatus 30 at step S11.

Note also that although, as illustrated in FIG. 4, it is described that the operation of transmitting a page response by the server apparatus 20 at step S17 is performed after the operation of transmitting a unique information response by the client apparatus 30 at step S16, the configuration is not limited thereto. Specifically, the operation of transmitting a page response by the server apparatus 20 at step S17 may be performed any time after the operation of obtaining a page by the server apparatus 20 at step S13, and may be performed independently of the operation at steps S14 to S16.

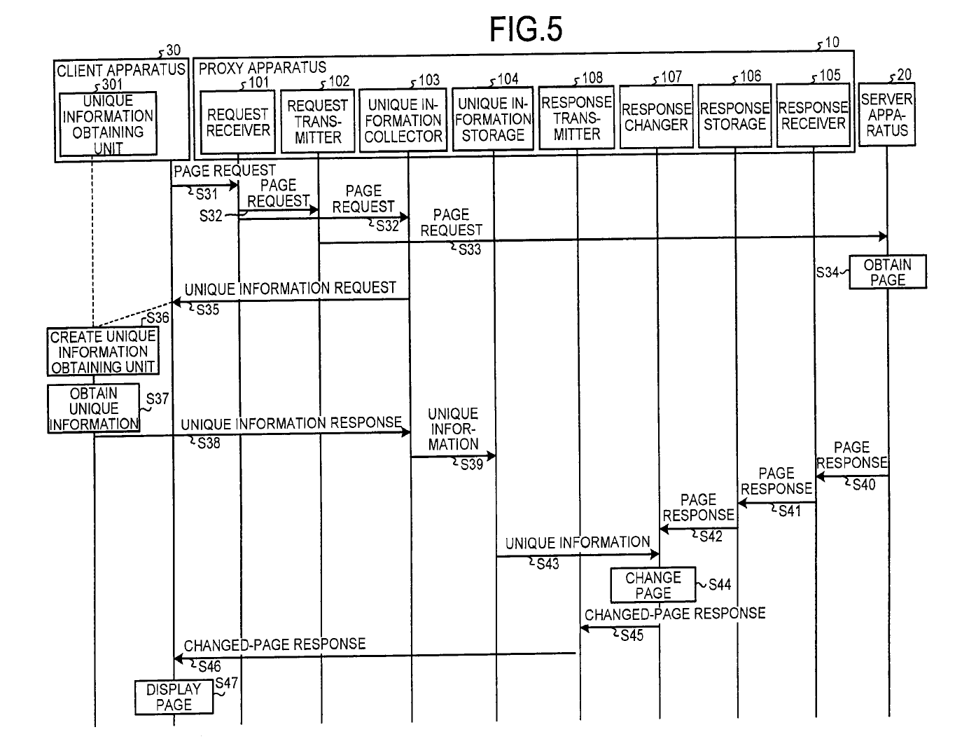

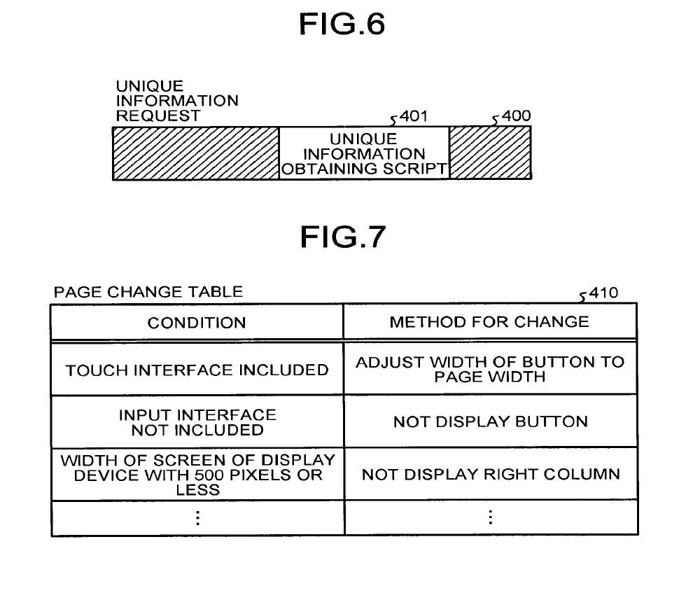

FIG. 5 is a sequence diagram illustrating details of the operation of the information processing system according to the first embodiment. FIG. 6 is a diagram illustrating an example of a data configuration of a unique information request. With reference to FIGS. 5 and 6, details of the operation of the information processing system 500 according to the present embodiment will be described according to the block configuration illustrated in FIG. 2.

Step S31

The client apparatus 30 transmits a page request for requesting a web page that a user desires to browse, to the request receiver 101 of the proxy apparatus 10.

Step S32

The request receiver 101 passes the received page request to the request transmitter 102 and the unique information collector 103 of the proxy apparatus 10.

Step S33

The request transmitter 102 transmits the received page request to the server apparatus 20 through the network 1.

Step S34

Based on the page request received from the request transmitter 102, the server apparatus 20 obtains a page requested by the client apparatus 30, from a storage apparatus of the server apparatus 20 such as the HDD 24.

Step S35

When the unique information collector 103 receives the page request, the unique information collector 103 transmits a unique information request instructing about the type, obtaining method, etc., of unique information required for page change operation, to the client apparatus 30 identified by the page request. The unique information request (unique information request 400 illustrated in FIG. 6) is, for example, composed in HTML format and includes a unique information obtaining script 401 which is a script executable on a browser. The above-described type, obtaining method, etc., of unique information required for page change operation are incorporated in the unique information obtaining script 401.

Step S36

When the client apparatus 30 receives the unique information request, the client apparatus 30 executes the unique information obtaining script 401 included in the unique information request on a browser, thereby creating a unique information obtaining unit 301 which operates on the browser.

Step S37

The unique information obtaining unit 301 obtains, by a predetermined obtaining method, unique information required for page change operation of the proxy apparatus 10, from the client apparatus 30.

Step S38

The unique information obtaining unit 301 transmits a unique information response including the obtained unique information, to the unique information collector 103. Note that the unique information obtaining unit 301 may establish communication by the WebSocket protocol so that the unique information obtaining unit 301 can perform communication at any timing to additionally transmit a unique information response even after transmitting the unique information response to the unique information collector 103. In this case, a script for establishing communication by the WebSocket protocol by the unique information obtaining unit 301 needs to be described in the unique information obtaining script 401 of the unique information request.

Step S39

The unique information collector 103 passes the unique information included in the received unique information response, to the unique information storage 104 of the proxy apparatus 10. The unique information storage 104 stores the received unique information.

Step S40

The server apparatus 20 transmits a page response including the page obtained at step S34, to the response receiver 105 of the proxy apparatus 10 through the network 1.

Step S41

The response receiver 105 passes the received page response to the response storage 106 of the proxy apparatus 10. The response storage 106 stores the received page response.

Step S42

The response changer 107 receives the page response stored in the response storage 106.

Step S43

The response changer 107 receives unique information associated with the client apparatus 30 identified by the received page response, from the unique information storage 104.

Step S44

Based on the received unique information, the response changer 107 page-changes the page included in the received page response, according to the display specifications of the browser, etc., of the client apparatus 30.

Step S45

The response changer 107 passes a changed-page response including the page-changed page (changed page), to the response transmitter 108 of the proxy apparatus 10.

Step S46

The response transmitter 108 transmits the received changed-page response to the client apparatus 30.

Step S47

The client apparatus 30 displays the changed page added to the received changed-page response, on the display device 35.

As in the above-described operation, when the unique information collector 103 receives a page request from the client apparatus 30, the unique information collector 103 transmits a unique information request specifying the type, obtaining method, etc., of unique information required for page change operation, to the client apparatus 30. A unique information obtaining script 401 included in the unique information request is executed on a browser of the client apparatus 30, thereby creating a unique information obtaining unit 301. The unique information obtaining unit 301 obtains, by a predetermined obtaining method, unique information required for page change operation of the proxy apparatus 10, from the client apparatus 30 and transmits a unique information response including the unique information to the unique information collector 103. Then, based on the unique information, the response changer 107 of the proxy apparatus 10 page-changes a page included in a page response from the server apparatus 20, according to the display specifications of the browser, etc., of the client apparatus 30. Therefore, the proxy apparatus 10 can specify to the client apparatus 30 required for page change operation, unique information related to display specifications, etc., by the unique information obtaining script 401 included in the unique information request. In addition, since the client apparatus 30 does not need to know in advance of unique information requested by the proxy apparatus 10, flexibility in the type of unique information which is obtained from the client apparatus 30 can be improved. Furthermore, since, as described above, the proxy apparatus 10 can obtain unique information which is obtained from the client apparatus 30, by the unique information obtaining script 401, the client apparatus 30 does not need to be equipped with a processor that obtains and transmits unique information.

Note that although, as illustrated in FIG. 5, it is described that the operation of transmitting a unique information request by the unique information collector 103 at step S35 is performed after the operation of obtaining a page by the server apparatus 20 at step S34, the configuration is not limited thereto. Specifically, the operation of transmitting a unique information request by the unique information collector 103 at step S35 may be performed any time after the unique information collector 103 receives a page request from the client apparatus 30 at step S32.

Note also that although, as illustrated in FIG. 5, it is described that the operation of transmitting a page response by the server apparatus 20 at step S40 is performed after the operation of transmitting a unique information response by the unique information obtaining unit 301 of the client apparatus 30 at step S38, the configuration is not limited thereto. Specifically, the operation of transmitting a page response by the server apparatus 20 at step S40 may be performed any time after the operation of obtaining a page by the server apparatus 20 at step S34, and may be performed independently of the operation at steps S35 to S39.

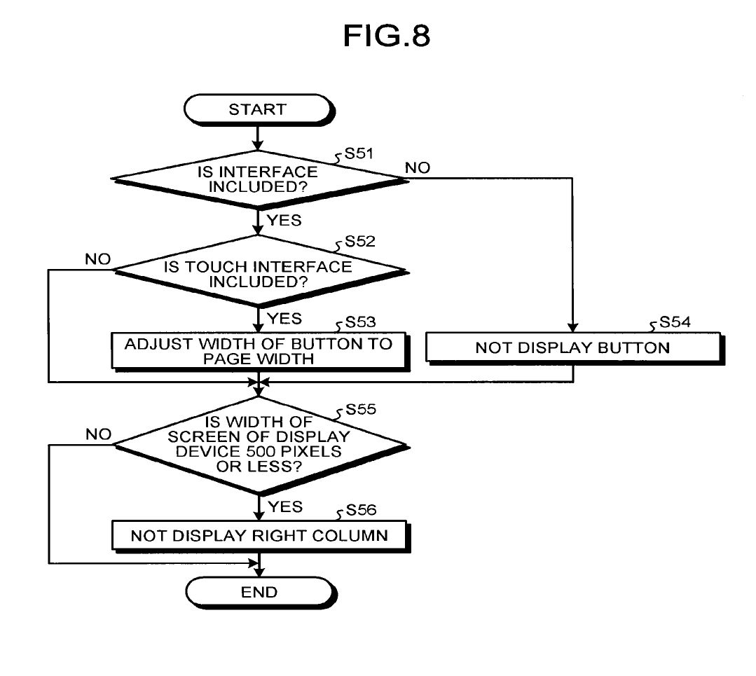

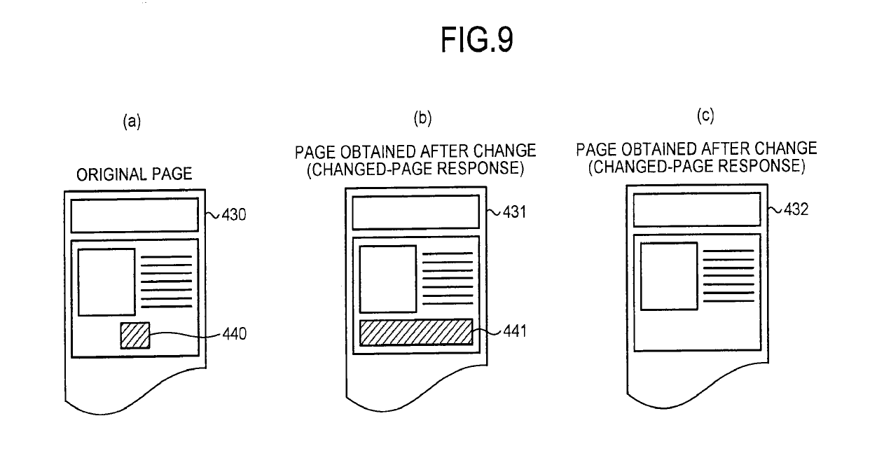

FIG. 7 is a diagram illustrating an example of a configuration of a page change table. FIG. 8 is a flowchart illustrating an example of the page change operation of the proxy apparatus. FIG. 9 illustrates examples of a page to which a page change is made. With reference to FIGS. 7 to 9, an example of the page change operation of the proxy apparatus 10 will be described.

The HDD 14 of the proxy apparatus 10 stores, for example, a page change table 410 illustrated in FIG. 7. The page change table 410 is a table where conditions regarding the display specifications of a client apparatus 30 identified by unique information are associated with the details of change to a page. By referring to the page change table 410, the response changer 107 of the proxy apparatus 10 makes a page change, according to the details of change to a page associated with conditions identified by received unique information.

The response changer 107 operates, for example, as in the flowchart illustrated in FIG. 8. In addition, it is assumed that a page included in a page response which is received by the response receiver 105 from the server apparatus 20 is, for example, a page 430 such as that illustrated in (a) in FIG. 9 and is described in HTML. It is assumed that the page 430 contains a button 440 on which a click/touch operation is performed by a user.

Step S51

The response changer 107 determines whether the conditions regarding a page change which are identified by unique information include the condition that the client apparatus 30 includes an input interface. If the conditions include the condition that the client apparatus 30 includes an input interface (step S51: Yes), the response changer 107 proceeds to step S52. If the conditions do not include the condition (step S51: No), the response changer 107 proceeds to step S54.

Step S52

The response changer 107 determines whether the conditions regarding a page change which are identified by unique information include the condition that the client apparatus 30 includes a touch interface. If the conditions include the condition that the client apparatus 30 includes a touch interface (step S52: Yes), the response changer 107 proceeds to step S53. If the conditions do not include the condition (step S52: No), the response changer 107 proceeds to step S55.

Step S53

The response changer 107 determines, from the conditions regarding a page change which are identified by unique information, that the client apparatus 30 includes an input interface and a touch interface. The response changer 107 determines, by referring to the page change table 410, that the methods for a page change to the page 430 associated with the conditions that an input interface and a touch interface are included are methods in which a button is displayed and the width of the button is adjusted to the page width. Then, for example, as illustrated in (b) in FIG. 9, the response changer 107 makes a page change to the page 430 such that the button 440 remains present and a button 441 where the width of the button 440 is adjusted to the page width is obtained, creating a page 431 (changed page) which is a page obtained after the change. Then, the response changer 107 proceeds to step S55.

Step S54

The response changer 107 determines, from the conditions regarding a page change which are identified by unique information, that the client apparatus 30 does not include an input interface. The response changer 107 determines, by referring to the page change table 410, that the method for a page change to the page 430 associated with the condition that an input interface is not included is a method in which a button is not displayed. Then, for example, as illustrated in (c) in FIG. 9, the response changer 107 makes a page change to the page 430 such that the button 440 is erased, creating a page 432 (changed page) which is a page obtained after the change. Then, the response changer 107 proceeds to step S55.

Step S55

The response changer 107 determines whether the conditions regarding a page change which are identified by unique information include the condition that the width of the screen of the display device 35 of the client apparatus 30 is 500 pixels or less. If the conditions include the condition that the width of the screen of the display device 35 of the client apparatus 30 is 500 pixels or less (step S55: Yes), the response changer 107 proceeds to step S56. If the conditions do not include the condition that the width of the screen is 500 pixels or less (step S55: No), the response changer 107 ends the page change operation.

Step S56

The response changer 107 determines, from the conditions regarding a page change which are identified by unique information, that the width of the screen of the display device 35 of the client apparatus 30 is 500 pixels or less. The response changer 107 determines, by referring to the page change table 410, that the method for a page change to the page 430 associated with the condition that the width of the screen of the display device 35 is 500 pixels or less is a method in which the right column of the screen is not displayed. Then, the response changer 107 makes a page change to the page 430 such that the right column is erased, creating a changed page. Then, the response changer 107 ends the page change operation.

Note that the conditions and the details of change to a page illustrated in the page change table 410 of FIG. 7 are exemplary and thus are not limited thereto. Note also that FIGS. 8 and 9 illustrate an example of operation and a page for when page change operation is performed according to the conditions and the details of change to a page in the page change table 410, and thus, the configuration is not limited thereto. The details of change to a page other than those illustrated in FIG. 7 include, for example, cutting out only a tree of a necessary portion from a DOM (Document Object Model) tree of an HTML file, changing the encoding scheme and compression rate of a media file, and replacing a URL (Uniform Resource Locator) described as a link destination with another URL.

As in the above-described configuration and operation of the information processing system 500, when the unique information collector 103 receives a page request from the client apparatus 30, the unique information collector 103 transmits a unique information request specifying the type, obtaining method, etc., of unique information required for page change operation, to the client apparatus 30. The client apparatus 30 creates a unique information obtaining unit 301, based on the unique information request. The unique information obtaining unit 301 obtains, by a predetermined obtaining method, unique information required for page change operation of the proxy apparatus 10, from the client apparatus 30 and transmits a unique information response including the unique information to the unique information collector 103. Then, based on the unique information, the response changer 107 page-changes a page included in a page response from the server apparatus 20, according to the display specifications of a browser, etc., of the client apparatus 30. Therefore, the proxy apparatus 10 can specify to the client apparatus 30 required for page change operation, unique information related to display specifications, etc., and obtain the unique information by the unique information obtaining unit 301 created based on the unique information request. In addition, since the client apparatus 30 does not need to know in advance of unique information requested by the proxy apparatus 10, flexibility in the type of unique information which is obtained from the client apparatus 30 can be improved. Furthermore, since, as described above, the proxy apparatus 10 can obtain unique information which is obtained from the client apparatus 30, by the unique information obtaining script 401, the client apparatus 30 does not need to be equipped with a processor that obtains and transmits unique information.

In addition, although, as illustrated in FIGS. 1 and 2, the proxy apparatus 10 and the server apparatus 20 are different apparatuses, the configuration is not limited thereto. The proxy apparatus 10 and the server apparatus 20 may be configured as an integral information processing apparatus, and the integral information processing apparatus may have a server function and a proxy function.

Variant of the First Embodiment

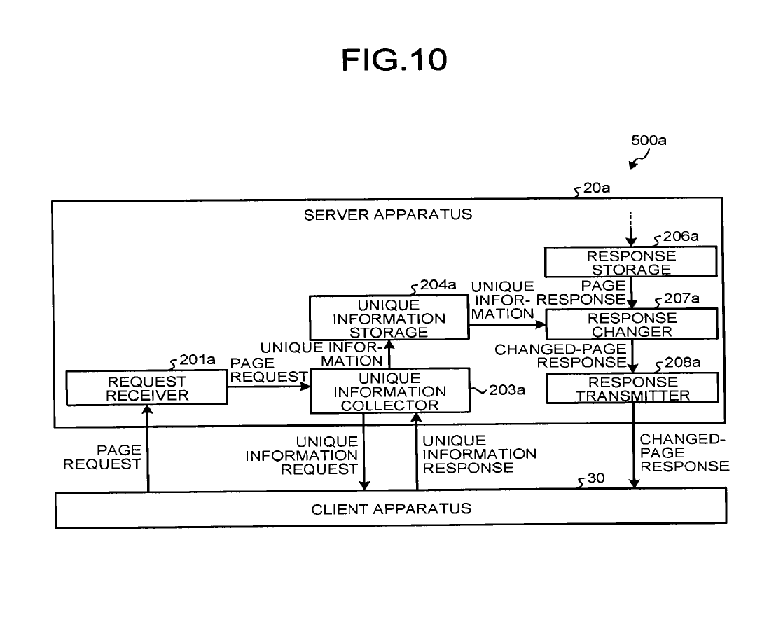

FIG. 10 is a diagram illustrating an example of a block configuration of an information processing system according to a variant of the first embodiment. With reference to FIG. 10, the configuration and operation of an information processing system 500a according to the present variant, mainly, a configuration and operation that differ from those of an information processing system 500 according to the first embodiment, will be described.

As illustrated in FIG. 10, the information processing system 500a includes a server apparatus 20a and a client apparatus 30. Though not illustrated in FIG. 10, the client apparatus 30 and the server apparatus 20a are connected to each other through a network.

Note that although in FIG. 10 only one client apparatus 30 connected to the server apparatus 20a through the network is described, the configuration is not limited thereto, and a plurality of client apparatuses 30 may be connected.

The hardware configurations of the server apparatus 20a and the client apparatus 30 illustrated in FIG. 10 are the same as those of the server apparatus 20 and the client apparatus 30 of the first embodiment illustrated in FIG. 1, respectively.

Next, with reference to FIG. 10, a block configuration of the information processing system 500a, particularly, a block configuration of the server apparatus 20a, will be described.

As illustrated in FIG. 10, the server apparatus 20a includes a request receiver 201a, a unique information collector 203a, a unique information storage 204a, a response storage 206a, a response changer 207a, and a response transmitter 208a.

The request receiver 201a is a processor that receives a page request from the client apparatus 30 and passes the page request to the unique information collector 203a. The request receiver 201a and the response transmitter 208a are implemented by a communication interface 21 (see FIG. 1).

The unique information collector 203a is a processor that receives the page request from the request receiver 201a and transmits a unique information request instructing about the type, obtaining method, etc., of unique information required for page change operation, to the client apparatus 30 identified by the page request. In addition, the unique information collector 203a receives a unique information response from the client apparatus 30 and passes unique information included in the unique information response, to the unique information storage 204a of the server apparatus 20a. The function of transmitting, by the unique information collector 203a, a unique information request to the client apparatus 30 and the function of receiving, by the unique information collector 203a, a unique information response from the client apparatus 30 are implemented by, for example, the communication interface 21. The function of generating, by the unique information collector 203a, a unique information request to be transmitted to the client apparatus 30 and the function of extracting, by the unique information collector 203a, unique information from a unique information response received from the client apparatus 30 and passing the unique information to the unique information storage 204a are implemented by a predetermined program which is deployed in a RAM 23 (see FIG. 1) and executed by a CPU 22 (see FIG. 1). Note that the function of generating, by the unique information collector 203a, a unique information request to be transmitted to the client apparatus 30 and the function of extracting, by the unique information collector 203a, unique information from a unique information response received from the client apparatus 30 and passing the unique information to the unique information storage 204a may be implemented by hardware.

The unique information storage 204a stores the unique information received from the unique information collector 203a. The unique information storage 204a is implemented by at least one of the RAM 23 and an HDD 24 (see FIG. 1).

The response storage 206a stores a page response including a web page that responds to the page request received by the request receiver 201a. The response storage 206a is implemented by at least one of the RAM 23 and the HDD 24.

The response changer 207a is a processor that receives unique information associated with the client apparatus 30 that is identified by the page response received from the response storage 206a, from the unique information storage 204a. Based on the unique information, the response changer 207a page-changes the page included in the page response, according to the display specifications of a browser, etc., of the client apparatus 30. The response changer 207a passes a changed-page response including the page-changed page (changed page) to the response transmitter 208a. The response changer 207a is implemented by a predetermined program which is deployed in the RAM 23 and executed by the CPU 22. Note that the response changer 207a may be implemented by hardware.

The response transmitter 208a is a processor that transmits the changed-page response received from the response changer 207a, to the client apparatus 30.

As described above, the information processing system 500a according to the present variant is a system in which the operation of collecting unique information from the client apparatus 30 by a unique information collector 103 and a unique information storage 104 of a proxy apparatus 10 of the information processing system 500 according to the first embodiment and the page change operation performed by a response storage 106 and a response changer 107 are performed by the server apparatus 20a. Specifically, the unique information collector 203a and the unique information storage 204a illustrated in FIG. 10 perform operation corresponding to the operation of collecting unique information from the client apparatus 30 by the unique information collector 103 and the unique information storage 104. In addition, the response storage 206a and the response changer 207a illustrated in FIG. 10 perform operation corresponding to the page change operation performed by the response storage 106 and the response changer 107. In a configuration such as that described above, the information processing system 500a also provides the same effects as those provided by the above-described information processing system 500 according to the first embodiment.

Note that although, as illustrated in FIG. 10, the information processing system 500a is configured such that the server apparatus 20a and the client apparatus 30 communicate with each other through the network, the configuration is not limited thereto. Specifically, the configuration may be such that a proxy apparatus is interposed between the server apparatus 20a and the client apparatus 30. In this case, the proxy apparatus has the function of relaying the transmission of a page request to the client apparatus 30 by the request receiver 201a, the transmission of a unique information request to the client apparatus 30 and the reception of a unique information response from the client apparatus 30 by the unique information collector 203a, and the reception of a changed-page response from the client apparatus 30 by the response transmitter 208a.

### Second Embodiment

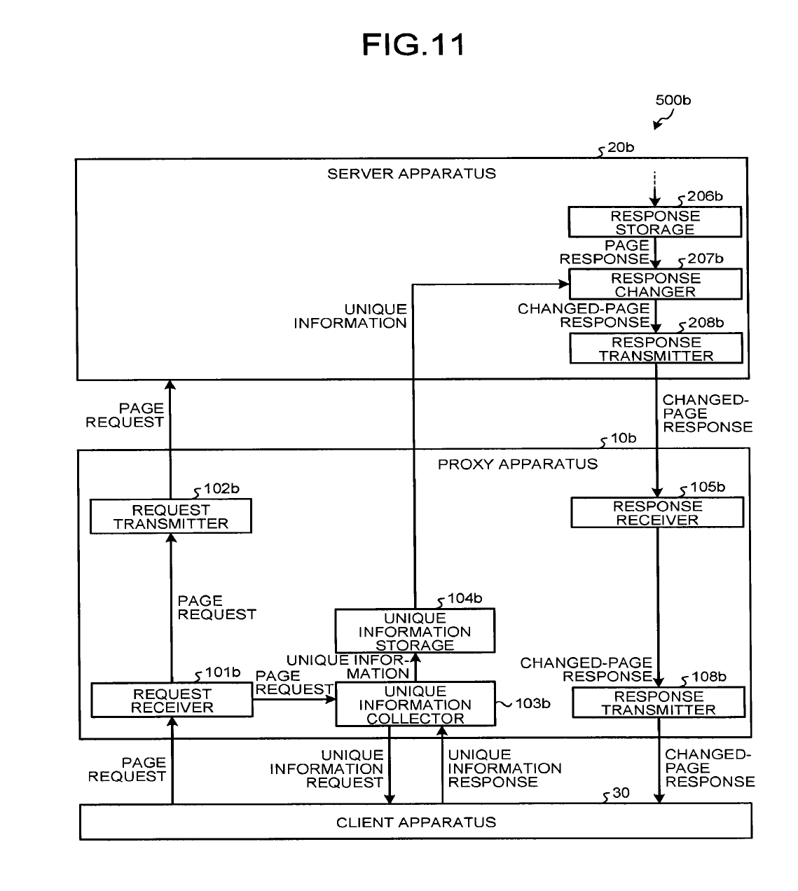

FIG. 11 is a diagram illustrating an example of a block configuration of an information processing system according to a second embodiment. With reference to FIG. 11, the configuration and operation of an information processing system 500b according to the present embodiment, mainly, a configuration and operation that differ from those of an information processing system 500 according to the first embodiment, will be described.

As illustrated in FIG. 11, the information processing system 500b includes a proxy apparatus 10b, a server apparatus 20b, and a client apparatus 30. The proxy apparatus 10b and the server apparatus 20b are connected to each other through an external network which is not illustrated. The client apparatus 30 is connected to the proxy apparatus 10b and is connected to the external network through the proxy apparatus 10b.

Note that although in FIG. 11 only one client apparatus 30 connected to the proxy apparatus 10b is described, the configuration is not limited thereto, and a plurality of client apparatuses 30 may be connected.

Note also that the client apparatus 30 is not limited to being directly connected to the proxy apparatus 10b, and for example, the client apparatus 30 may be connected to the proxy apparatus 10b through a LAN such as an intra-company network.

The hardware configurations of the proxy apparatus 10b, the server apparatus 20b, and the client apparatus 30 illustrated in FIG. 11 are the same as those of a proxy apparatus 10, a server apparatus 20, and a client apparatus 30 of the first embodiment illustrated in FIG. 1, respectively.

Next, with reference to FIG. 11, a block configuration of the information processing system 500b, particularly, the block configurations of the proxy apparatus 10b and the server apparatus 20b, will be described.

As illustrated in FIG. 11, the proxy apparatus 10b includes a request receiver 101b, a request transmitter 102b, a unique information collector 103b, a unique information storage 104b, a response receiver 105b, and a response transmitter 108b.

The request receiver 101b is a processor that receives a page request from the client apparatus 30 and passes the page request to the request transmitter 102b and the unique information collector 103b. The request receiver 101b, and the request transmitter 102b, the response receiver 105b, and the response transmitter 108b which will be described later are implemented by a communication interface 11 (see FIG. 1).

The request transmitter 102b is a processor that receives the page request from the request receiver 101b and transmits the page request to the server apparatus 20b through the network.

The unique information collector 103b is a processor that receives the page request from the request receiver 101b and transmits a unique information request instructing about the type, obtaining method, etc., of unique information required for page change operation, to the client apparatus 30 identified by the page request. In addition, the unique information collector 103b receives a unique information response from the client apparatus 30 and passes unique information included in the unique information response, to the unique information storage 104b of the proxy apparatus 10b. The function of transmitting a unique information request to the client apparatus 30 by the unique information collector 103b and the function of receiving a unique information response from the client apparatus 30 by the unique information collector 103b are implemented by, for example, the communication interface 11. The function of generating, by the unique information collector 103b, a unique information request to be transmitted to the client apparatus 30 and the function of extracting, by the unique information collector 103b, unique information from a unique information response received from the client apparatus 30 and passing the unique information to the unique information storage 104b are implemented by a predetermined program which is deployed in a RAM 13 (see FIG. 1) and executed by a CPU 12 (see FIG. 1). Note that the function of generating, by the unique information collector 103b, a unique information request to be transmitted to the client apparatus 30 and the function of extracting, by the unique information collector 103b, unique information from a unique information response received from the client apparatus 30 and passing the unique information to the unique information storage 104b may be implemented by hardware.

The unique information storage 104b stores the unique information received from the unique information collector 103b. The unique information storage 104b is implemented by at least one of the RAM 13 and an HDD 14 (see FIG. 1).

The response receiver 105b is a processor that receives a changed-page response from a response transmitter 208b of the server apparatus 20b which will be described later, through the network and passes the changed-page response to the response transmitter 108b.

The response transmitter 108b transmits the changed-page response received from the response receiver 105b, to the client apparatus 30.

As illustrated in FIG. 11, the server apparatus 20b includes a response storage 206b, a response changer 207b, and the response transmitter 208b.

The response storage 206b stores a page response including a web page that responds to the page request received by the server apparatus 20b. The response storage 206b is implemented by at least one of a RAM 23 (see FIG. 1) and an HDD 24 (see FIG. 1).

The response changer 207b is a processor that receives unique information associated with the client apparatus 30 that is identified by the page response received from the response storage 206b, from the unique information storage 104b of the proxy apparatus 10b through the network. Based on the unique information, the response changer 207b page-changes the page included in the page response, according to the display specifications of a browser, etc., of the client apparatus 30. The response changer 207b passes a changed-page response including the page-changed page (changed page) to the response transmitter 208b. The response changer 207b is implemented by a predetermined program which is deployed in the RAM 23 and executed by a CPU 22 (see FIG. 1). Note that the response changer 207b may be implemented by hardware.

The response transmitter 208b is a processor that transmits the changed-page response received from the response changer 207b, to the response receiver 105b of the proxy apparatus 10b through the network.

As described above, the information processing system 500b according to the present embodiment is a system in which the page change operation performed by a response storage 106 and a response changer 107 of the proxy apparatus 10 of the information processing system 500 according to the first embodiment is performed by the server apparatus 20b. In addition, in the information processing system 500b, the operation of collecting unique information from the client apparatus 30 by a unique information collector 103 and a unique information storage 104 of the proxy apparatus 10 of the information processing system 500 according to the first embodiment is performed by the proxy apparatus 10b. Specifically, the response storage 206b and the response changer 207b of the server apparatus 20b illustrated in FIG. 11 perform operation corresponding to the page change operation performed by the response storage 106 and the response changer 107. In addition, the unique information collector 103b and the unique information storage 104b of the proxy apparatus 10b illustrated in FIG. 11 perform operation corresponding to the operation of collecting unique information from the client apparatus 30 by the unique information collector 103 and the unique information storage 104. In a configuration such as that described above, the information processing system 500b also provides the same effects as those provided by the above-described information processing system 500 according to the first embodiment.

In addition, since the operation of collecting unique information from the client apparatus 30 is performed by the proxy apparatus 10b and the page change operation is performed by the server apparatus 20b, the processing load can be distributed, enabling to improve the processing speed of each operation.

Variant of the Second Embodiment

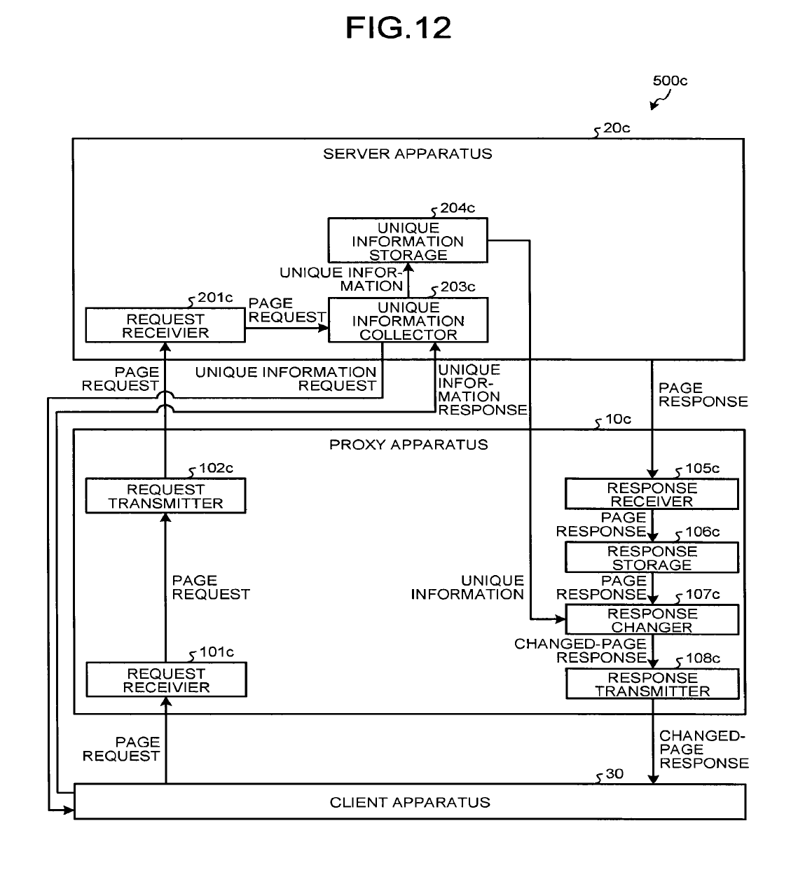

FIG. 12 is a diagram illustrating an example of a block configuration of an information processing system according to a variant of the second embodiment. With reference to FIG. 12, mainly, a configuration and operation of an information processing system 500c according to the present variant that differ from those of an information processing system 500 according to the first embodiment will be described.

As illustrated in FIG. 12, the information processing system 500c includes a proxy apparatus 10c, a server apparatus 20c, and a client apparatus 30. The proxy apparatus 10c and the server apparatus 20c are connected to each other through an external network which is not illustrated.

Note that although in FIG. 12 only one client apparatus 30 connected to the proxy apparatus 10c is described, the configuration is not limited thereto, and a plurality of client apparatuses 30 may be connected.

Note also that the client apparatus 30 is not limited to being directly connected to the proxy apparatus 10c, and for example, the client apparatus 30 may be connected to the proxy apparatus 10c through a LAN such as an intra-company network.

The hardware configurations of the proxy apparatus 10c, the server apparatus 20c, and the client apparatus 30 illustrated in FIG. 12 are the same as those of a proxy apparatus 10, a server apparatus 20, and a client apparatus 30 of the first embodiment illustrated in FIG. 1, respectively.

Next, with reference to FIG. 12, a block configuration of the information processing system 500c, particularly, the block configurations of the proxy apparatus 10c and the server apparatus 20c, will be described.

As illustrated in FIG. 12, the proxy apparatus 10c includes a request receiver 101c, a request transmitter 102c, a response receiver 105c, a response storage 106c, a response changer 107c, and a response transmitter 108c.

The request receiver 101c is a processor that receives a page request from the client apparatus 30 and passes the page request to the request transmitter 102c. The request receiver 101c, the request transmitter 102c, the response receiver 105c, and the response transmitter 108c are implemented by a communication interface 11 (see FIG. 1).

The request transmitter 102c is a processor that receives the page request from the request receiver 101c and transmits the page request to the server apparatus 20c through the network.

The response receiver 105c is a processor that receives a page response from the server apparatus 20c through the network and passes the page response to the response storage 106c.

The response storage 106c stores the page response received from the response receiver 105c. The response storage 106c is implemented by at least one of a RAM 13 (see FIG. 1) and an HDD 14 (see FIG. 1).

The response changer 107c is a processor that receives unique information associated with the client apparatus 30 that is identified by the page response received from the response storage 106c, from a unique information storage 204c of the server apparatus 20c. Based on the unique information, the response changer 107c page-changes a page included in the page response, according to the display specifications of a browser, etc., of the client apparatus 30. The response changer 107c passes a changed-page response including the page-changed page (changed page) to the response transmitter 108c. The response changer 107c is implemented by a predetermined program which is deployed in the RAM 13 and executed by a CPU 12 (see FIG. 1). Note that the response changer 107c may be implemented by hardware.

The response transmitter 108c is a processor that transmits the changed-page response received from the response changer 107c, to the client apparatus 30.

As illustrated in FIG. 12, the server apparatus 20c includes a request receiver 201c, a unique information collector 203c, and the unique information storage 204c.

The request receiver 201c is a processor that receives the page request from the request transmitter 102c of the proxy apparatus 10c and passes the page request to the unique information collector 203c. The request receiver 201c is implemented by a communication interface 21 (see FIG. 1).

The unique information collector 203c is a processor that receives the page request from the request receiver 201c and transmits a unique information request instructing about the type, obtaining method, etc., of unique information required for page change operation, to the client apparatus 30 identified by the page request. In addition, the unique information collector 203c receives a unique information response from the client apparatus 30 and passes unique information included in the unique information response, to the unique information storage 204c of the server apparatus 20. The function of transmitting, by the unique information collector 203c, a unique information request to the client apparatus 30 and the function of receiving, by the unique information collector 203c, a unique information response from the client apparatus 30 are implemented by, for example, the communication interface 21. The function of generating, by the unique information collector 203c, a unique information request to be transmitted to the client apparatus 30 and the function of extracting, by the unique information collector 203c, unique information from a unique information response received from the client apparatus 30 and passing the unique information to the unique information storage 204c are implemented by a predetermined program which is deployed in a RAM 23 (see FIG. 1) and executed by a CPU 22 (see FIG. 1). Note that the function of generating, by the unique information collector 203c, a unique information request to be transmitted to the client apparatus 30 and the function of extracting, by the unique information collector 203c, unique information from a unique information response received from the client apparatus 30 and passing the unique information to the unique information storage 204c may be implemented by hardware.

The unique information storage 204c stores the unique information received from the unique information collector 203c. The unique information storage 204c is implemented by at least one of the RAM 23 and an HDD 24 (see FIG. 1).

As described above, the information processing system 500c according to the present embodiment is a system in which the operation of collecting unique information from the client apparatus 30 by a unique information collector 103 and a unique information storage 104 of the proxy apparatus 10 of the information processing system 500 according to the first embodiment is performed by the server apparatus 20c. In addition, in the information processing system 500c, the page change operation performed by a response storage 106 and a response changer 107 of the proxy apparatus 10 of the information processing system 500 according to the first embodiment is performed by the proxy apparatus 10c. Specifically, the unique information collector 203c and the unique information storage 204c of the server apparatus 20c illustrated in FIG. 12 perform operation corresponding to the operation of collecting unique information from the client apparatus 30 by the unique information collector 103 and the unique information storage 104. In addition, the response storage 106c and the response changer 107c of the proxy apparatus 10c illustrated in FIG. 12 perform operation corresponding to the page change operation performed by the response storage 106 and the response changer 107. In a configuration such as that described above, too, the information processing system 500c provides the same effects as those provided by the above-described information processing system 500 according to the first embodiment.

In addition, since the operation of collecting unique information from the client apparatus 30 is performed by the server apparatus 20c and the page change operation is performed by the proxy apparatus 10c, the processing load can be distributed, enabling to improve the processing speed of each operation.

Note that although, as illustrated in FIG. 12, a unique information request and a unique information response are directly transmitted and received between the server apparatus 20c and the client apparatus 30, the configuration is not limited thereto, and the transmission and reception may be performed through the proxy apparatus 10c.

Each program executed in the server apparatus, the proxy apparatus, and the client apparatus as described above may be provided as a computer program product such as a computer readable medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a unique information collector configured to transmit a unique information request to a client apparatus, and receive unique information from the client apparatus, the unique information request being to request the unique information of the client apparatus;
a response changer configured to change, based on the unique information, a page included in a page response received from a server apparatus, and output the changed page, the page response responding to a page request transmitted from the client apparatus; and
a response transmitter configured to transmit the changed page to the client apparatus.

2. The system according to claim 1, wherein the unique information collector is configured to transmit the unique information request to the client apparatus having transmitted the page request, after receiving the page request from the client apparatus.

3. The system according to claim 1, wherein
the client apparatus is configured to create a unique information obtaining unit in response to receiving the unique information request from the unique information collector, and
the unique information obtaining unit is configured to obtain the unique information from the client apparatus and transmit the unique information to the unique information collector.

4. The system according to claim 3, wherein the client apparatus is configured to create the unique information obtaining unit by executing a script included in the unique information request.

5. The system according to claim 1, further comprising:
a unique information storage configured to store therein the unique information received by the unique information collector; and
a response storage configured to store therein the page response, wherein
the response changer is configured to change the page included in the page response stored in the response storage, based on the unique information stored in the unique information storage.

6. The system according to claim 5, wherein
the unique information storage is configured to store therein the unique information and identification information of the client apparatus associated with the unique information such that the unique information and the identification information are associated with each other, and
the response changer is configured to identify the client apparatus by the page response stored in the response storage, and change the page included in the page response, based on the unique information associated with the client apparatus stored in the unique information storage.

7. A proxy apparatus comprising:
a unique information collector configured to transmit a unique information request to a client apparatus, and receive unique information from the client apparatus, the unique information request being to request the unique information of the client apparatus;
a response changer configured to change, based on the unique information, a page included in a page response received from a server apparatus, and output the changed page, the page response responding to a page request transmitted from the client apparatus; and
a response transmitter configured to transmit the changed page to the client apparatus.

8. An information processing method comprising:
transmitting a unique information request to a client apparatus;
receiving unique information from the client apparatus, the unique information request being to request the unique information of the client apparatus;
changing, based on the unique information, a page included in a page response received from a server apparatus, and output the changed page, the page response responding to a page request transmitted from the client apparatus; and
transmitting the changed page to the client apparatus.

9. A computer program product comprising a computer-readable medium containing a program executed by a computer, the program causing the computer to execute:
transmitting a unique information request to a client apparatus;
receiving unique information from the client apparatus, the unique information request being to request the unique information of the client apparatus;
changing, based on the unique information, a page included in a page response received from a server apparatus, and output the changed page, the page response responding to a page request transmitted from the client apparatus; and
transmitting the changed page to the client apparatus.
